(19) United States
(12) Patent Application Publication
(10) Pub. No.: US 2007/0076946 A1
(43) Pub. Date: Apr. 5, 2007

(54) Object search apparatus, robot system equipped with object search apparatus, and object search method

(75) Inventors: Akira Kunisaki, Takaoka-shi (JP); Masayuki Nakaya, Toyama-shi (JP); Katsutoshi Ohno, Toyama-shi (JP)

Correspondence Address: VENABLE LLP, P.O. BOX 34385, WASHINGTON, DC, 20043-9998, US

(73) Assignee: Nachi-Fujikoshi Corp., Toyama-Shi (JP)

(21) Appl. No.: 11/529,492

(22) Filed: Sep. 29, 2006

(30) Foreign Application Priority Data
Sep. 30, 2005 (JP) 2005-287421

(51) Int. Cl. G06K 9/00

(52) U.S. Cl. 382/153

(57) ABSTRACT

Disclosed is an object search apparatus, including: an imaging unit to acquire image data of a point group; a radiation unit to scan the imaging area; a three-dimensional analysis unit to calculate three-dimensional data indicating position coordinates of the point group, from the image data; a master data storage unit to store a master data which is each of the three-dimensional data of a search object to be searched in the imaging area in a plurality of directions; and a judgment unit to position one point of the master data in each direction to each point of the three-dimensional data, to judge whether position coordinates of points of the positioned master data in any direction approach to position coordinates of corresponding points of the three-dimensional data of the imaging area, and to perform a search of the search object based on a result of the judgment.

### BACKGROUND OF THE INVENTION

1. Field of the Invention

The present invention relates to an object search apparatus and an object search method, each using an imaging unit, and a robot system equipped with the object search apparatus.

2. Description of Related Art

An object search apparatus is installed in, for example, the system of an industrial robot, and is used in order to search for a workpiece which is an object for robot operation.

A conventional object search apparatus scans an area on a palette on which a workpiece is prepared with slit light or spot light, and images the workpiece with a visual sensor using a camera. Then, the conventional object search apparatus calculates a radiation position of the light based on a camera visual line and the radiation direction of the light, and acquires three-dimensional data in the imaging area, so as to acquire the position of the workpiece (for example, see WO97/024206A)

However, the conventional object search apparatus has a disadvantage that it is difficult to detect a workpiece position when the workpiece is placed on a pallet in a direction out of a predetermined direction although it is possible to easily detect the workpiece position when the workpiece is placed on the pallet in the predetermined direction.

Furthermore, when workpieces are sparsely placed on the pallet, namely when each of the workpieces is placed to be distant from the other workpieces, the conventional imaging apparatus can detect the workpieces because the shape of each of the workpieces is embossed from the flat surface around the workpiece.

However, when a plurality of workpieces are densely or confusedly piled on one another on the pallet, detected three-dimensional data shows a complicated shape. The conventional imaging apparatus has a disadvantage that it is difficult to detect the position and direction of each workpiece based on such three-dimensional data.

### SUMMARY OF THE INVENTION

It is an object of the present invention to provide an object search apparatus, a robot system equipped with object search apparatus and an object search method, each of which can individually search objects which are placed without being aligned in a predetermined direction or are randomly piled.

In order to attain the above object, according to a first aspect of the present invention, an object search apparatus, comprising: an imaging unit to acquire image data of a point group acquired by imaging and breaking down an imaging area; a radiation unit to scan the imaging area with laser light; a three-dimensional analysis unit to calculate three-dimensional data indicating position coordinates of the point group acquired by breaking down the imaging area, from the image data acquired by scanning of the radiation unit with the laser light; a master data storage unit to store a master data which is each of the three-dimensional data of a search object to be searched in the imaging area in a plurality of directions; and a judgment unit to position one point of the master data in each direction to each point of the three-dimensional data, to judge whether position coordinates of points of the positioned master data in any direction approach to position coordinates of corresponding points of the three-dimensional data of the imaging area, and to perform a search of the search object based on a result of the judgment.

To put it concretely, while the radiation unit scans the imaging area with the laser light, the imaging unit performs the imaging. Thereby, the image data imaging each position of the imaging area radiated and scanned by the laser light is acquired.

A three-dimensional coordinate of a radiation position in the imaging area is calculated from a radiation position of the laser light in the imaging area, a radiation direction of the laser light and the direction of the visual point of the imaging unit. The three-dimensional coordinate of the laser light radiated to each point (point group) in the whole imaging area is acquired by the scan, and the three-dimensional data in the imaging area is generated.

On the other hand, the master data storage unit stores the three-dimensional data indicating the three-dimensional position coordinates of a plurality of points (the point group) on the surface of the search object placed in various directions.

Then, it is judged whether the position coordinate of the point group of the master data approach to the position coordinate of the circumferential point group of the three-dimensional data in the imaging area or not when one point of the master data is positioned to the position of one point of the three-dimensional data in the imaging area. Such judgment is preformed by positioning optional one point in the master data in each direction to each point of the three-dimensional data in the imaging area. The one point of the master data may be the same or different point between the master data in all directions.

The judgment is performed to the point group of the three-dimensional data in the imaging area sequentially. When the position coordinates of the point group in the three-dimensional data at a certain point of the imaging area approach to the master data of the search object in any direction, a search result can be acquired that the search object facing to the corresponding direction exists in the state the one point thereof locates at the point of the three-dimensional data.

The position of the search object is searched based on whether the position coordinate of the other points approach or not after the position of one point of the master data is adjusted to the one point of the imaging area as described above. Consequently, even in the state that a plurality of search objects is confusedly piled on one another and the three-dimensional data acquired by imaging shows a complicated shape, it becomes possible to search one search object from the approximation of a part of the three-dimensional data.

Furthermore, because the resemblance with each of the master data of the search object in a plurality of directions is judged, it becomes possible to search the search objects in various directions. The object search apparatus may further comprises a direction memory unit to store direction of the search object of each master data, and a direction specifying unit to read out the stored direction of the search object corresponding to the master data which the judging unit judges to approach. By doing so, it becomes possible to specify the direction of the search object based on which direction of the master data the searched search object resembles to.

In addition, it is unnecessary to perform the approximation judgment to all point groups of the three-dimensional data in the imaging area. For example, the approximation judgment may be performed to a part of the points which is thinned out with a predetermined interval, or points which can be previously identified to be those of a mounting plane on which the search object is placed among the point groups of the three-dimensional data in the imaging area may be excluded from the objects of the judgment.

Preferably, the object search apparatus further comprises: a master data acquisition unit to acquire the master data of the search object in a plurality of directions by the imaging unit imaging the search object while the radiation unit scanning the search object with the laser light.

To put it concretely, the master data of a search object is acquired by the following procedure. That is, the radiation unit performs the scan of the search object placed in the imaging area with the laser light, while the imaging unit performs imaging. Thereby, image data of the laser light radiating each position of the searching subject by the scan is acquired.

The three-dimensional coordinate of each point (point group) on the surface of the search object is calculated based on the radiation position of the laser light in the imaging area, the radiation direction of the laser light and the direction of the visual point of the imaging unit. The three-dimensional data of the search object is generated as the master data in the direction to which the search object has faced at the time of imaging. The above acquisition of the master data is repeated to the search object in various directions. Thus, the master data of the search object in all directions are stored in the master data storing unit.

Preferably, the object search apparatus further comprises: a master data acquisition unit to calculate the master data of the search object in a certain direction by the imaging unit imaging the search object while the radiation unit scanning the search object with the laser light, and to calculate the master data in a plurality of directions by coordinate conversion to change a direction of the master data.

To put it concretely, the master data of a search object is acquired by the following procedure. That is, the radiation unit performs the scan of the search object placed in the imaging area with the laser light, while the imaging unit performs imaging. Thereby, image data of the laser light radiating each position of the searching subject by the scan is acquired.

The three-dimensional coordinate of each point (point group) on the surface of the search object is calculated based on the radiation position of the laser light in the imaging area, the radiation direction of the laser light and the direction of the visual point of the imaging unit. The three-dimensional data of the search object is generated as the master data in the direction to which the search object has faced at the time of imaging.

Furthermore, coordinate conversion for changing the direction of the master data in the above direction is performed, and the master data of the search object facing to various directions are calculated and stored in the master data storage unit.

In this way, because the master data is acquired by using the imaging unit and the radiation unit, it becomes possible to perform the search even if the master data of the search object is not known.

Moreover, it becomes possible to prepare the master data of a high degree of coincidence at the time of the approximation judgment by equalizing scan conditions and imaging conditions in the case of acquiring the master data of the search object and in the case of acquiring the three-dimensional data of the imaging area to be searched, and then it becomes possible to improve the searching accuracy.

Preferably, the judgment unit performs the judgment on a part of points arranged at predetermined interval among the point group of the three-dimensional data of the imaging area acquired by the three-dimensional analysis unit, and further performs the judgment on points arranged at denser interval than the predetermined interval only within a circumference of the point at which a degree of approximation has judged high.

To put it concretely, in the case of performing the position adjustment of one point of the master data and the judgment of the approximation, first, the position adjustment and the judgment are performed only to some pieces of data distant from each other in a predetermined interval without performing the position adjustment and the judgment to all of the points of the three-dimensional data of the imaging area acquired by the three-dimensional analysis unit.

With regard to the point having a high degree of approximation as a result, the position adjustment and the judgment of the points are performed to the points which are denser arranged around the point, or to a plurality of points around the point within a predetermined area in order to narrow down the points having higher degrees of approximation.

Consequently, it becomes unnecessary to perform the position adjustment and the judgment to all of the points of the three-dimensional data of the imaging area acquired from the three-dimensional analysis, and it becomes possible to attain the reduction of the processing load and the speeding up of processing.

In addition, the judgment of whether the degree of approximation is high or not may be judged based on, for example, whether the degree of approximation is higher than a previously set value, or may be judged based on whether the order of the degree of approximation of each point falls in a predetermined order or not by acquiring the order.

According to a second aspect of the invention, a robot system equipped with the object search apparatus according to the first aspect, comprising: a robot to hold a tool to perform an operation to the search object; and a robot control apparatus to control the robot to move and position the tool based on a position of the search object acquired by the search apparatus.

To put it concretely, the object search apparatus acquires the position of the search object placed in the imaging area. Then, the robot control apparatus positions the tool of the robot based on the acquired position of the search object in order to perform the predetermined operation to the search object.

Consequently, for example, even if a plurality of search objects are confusedly piled on one another, it is possible to perform the operation according to the kind of the tool to one search object among them. Thus, it is not necessary to arrange the search objects previously in order to perform the operation of the robot, and it becomes possible to attain the reduction of the operation load.

Preferably, the tool is a hand to hold the search object, and the robot control apparatus controls the robot to hold and carry the search object with the hand based on a position and a direction of the search object acquired by the search apparatus.

To put it concretely, the hand of the robot is positioned based on the position and the direction of the search object acquired by the object search apparatus in order to hold and carry the search object.

Consequently, for example, even if a plurality of search objects are confusedly piled on one another, it becomes possible to hold and carry one search object among them. Thereby, the reduction of the operation load is attained, and it becomes possible to perform the operations which have been difficult in earlier development such as the rearrangement of the search objects confusedly piled up one another.

According to a third aspect of the invention, an object search method using an object search apparatus comprising an imaging unit to acquire image data of a point group acquired by imaging and breaking down an imaging area, a radiation unit to scan the imaging area with laser light, a three-dimensional analysis unit to calculate three-dimensional data indicating position coordinates of the point group acquired by breaking down the imaging area from the image data acquired by scanning with the laser light, and a master data storage unit to store a master data which is each of the three-dimensional data of a search object to be searched in the imaging area in a plurality of directions, the method comprising the steps of: positioning one point of the master data in each direction to each point of the three-dimensional data of the imaging area acquired by the three-dimensional analysis unit; judging whether position coordinates of points of the positioned master data in any direction approach to position coordinates of corresponding points of the three-dimensional data; and specifying a direction and a position of the search object based on a result of the judgment.

Preferably, the object search method further comprises the steps of: acquiring the master data of the search object in a plurality of directions by the imaging unit imaging the search object while the radiation unit scanning of the search object with the laser light.

Preferably, the object search method further comprises the steps of: calculating the master data of the search object in a certain direction by the imaging unit imaging the search object while the radiation unit scanning the search object with the laser light; and calculating the master data in a plurality of directions by coordinate conversion to change a direction of the master data.

Preferably, the positioning and the judging are performed to a part of points arranged at predetermined interval among the point group of the three-dimensional data of the imaging area acquired by the three-dimensional analysis unit, and further are performed to points arranged at denser interval than the predetermined interval only within a circumference of the point at which a degree of approximation has judged high.

### BRIEF DESCRIPTION OF THE DRAWINGS

The present invention will become more fully understood from the detailed description given hereinbelow and the appended drawings which given by way of illustration only, and thus are not intended as a definition of the limits of the present invention, and wherein;

FIG. 1 is a view showing the whole configuration of a robot system of an embodiment according to the present invention;

FIG. 2 is a block diagram showing the control system of the object search apparatus shown in FIG. 1;

FIGS. 3A, 3B and 3C are views showing a jig for measuring distances to be used for pixel interval measurement processing, FIG. 3A is a perspective view thereof, FIG. 3B is a plan view thereof, and FIG. 3C shows an imaged image at the time of using the jig;

FIG. 4 is a flowchart showing the processing executed by the CPU in accordance with a pixel interval measurement program;

FIG. 5 is an explanatory view of the principle of camera distance calculation processing;

FIG. 6 is a flowchart showing the processing executed by the CPU in accordance with a camera distance calculation program;

FIG. 7 is an explanatory view showing the principle of laser angle calculation processing;

FIG. 8 is a flowchart showing the processing executed by the CPU in accordance with a laser angle calculation program;

FIGS. 9A is an explanatory view of the state in which a laser slit light is radiated to a workpiece put in an imaging area at a certain radiation angle, and FIG. 9B is a diagram showing the imaged image;

FIG. 10 is a flowchart showing the processing executed by the CPU in accordance with a master data acquisition program;

FIG. 11 is a flowchart showing the processing executed by the CPU in accordance with the three-dimensional analysis program;

FIGS. 12A, 12B and 12C are explanatory views of the principle of judgment processing, FIG. 12A shows a disagreement state of positions, FIG. 12B shows a disagreement state of directions, and FIG. 12C shows a coincidence state of both the positions and the directions;

FIG. 13 is a flowchart showing the processing executed by the CPU in accordance with a judgment program; and

FIG. 14 is a block diagram of the robot control apparatus shown in FIG. 1.

### DETAILED DESCRIPTION OF THE PREFERRED EMBODIMENTS

(Whole Configuration of Embodiment of Present Invention)

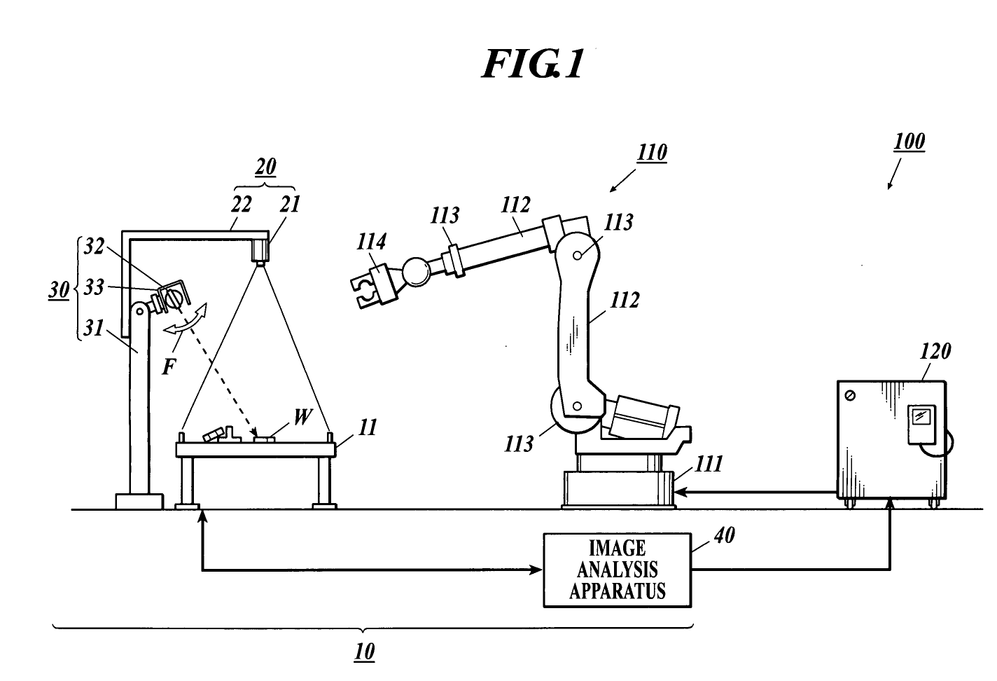

FIG. 1 is the whole configuration view of a robot system 100, which is an embodiment of the present invention.

The robot system 100 is a system for recognizing the position and the direction of each workpiece W by an object search in a state in which the workpieces W are confusedly piled up on a pallet 11, and for holding the workpieces W to carry the workpieces W to an object position.

Such a robot system 100 is composed of an object search apparatus 10, a robot 110 having a hand 114 as a tool to perform the operations of holding and carrying a workpiece W acquired by a search, and a robot control apparatus 120 to perform the operation control of the holding and the carrying operations of the robot 110 based on the position of the workpiece W acquired by the search. The object search apparatus 10 is composed of an imaging apparatus 20 as an imaging unit to acquire image data of a point group, which is acquired by breaking down an imaging area, by imaging; a laser radiation apparatus 30 as a radiation unit to perform the scan of the imaging area with a laser light; and an image analysis apparatus 40 to analyze the image data acquired by the imaging of the laser light scan.

In the following, each section will be individually described in detail.

(Laser Radiation Apparatus of Object Search Apparatus)

The laser radiation apparatus 30 of the object search apparatus 10 is equipped with a stand 31, a laser oscillator 32 to emit a laser light, and a scan mechanism 33 to support the laser oscillator 32 at the upper part of the stand 31 in a state capable of rotating the laser oscillator 32 around two axes perpendicular to each other to drive the laser oscillator 32.

The laser oscillator 32 emits a predetermined single wavelength light as a laser light. An optical system to change the laser light to a slit light to emit the changed slit light to the side of the pallet 11 is installed together with the laser oscillator 32.

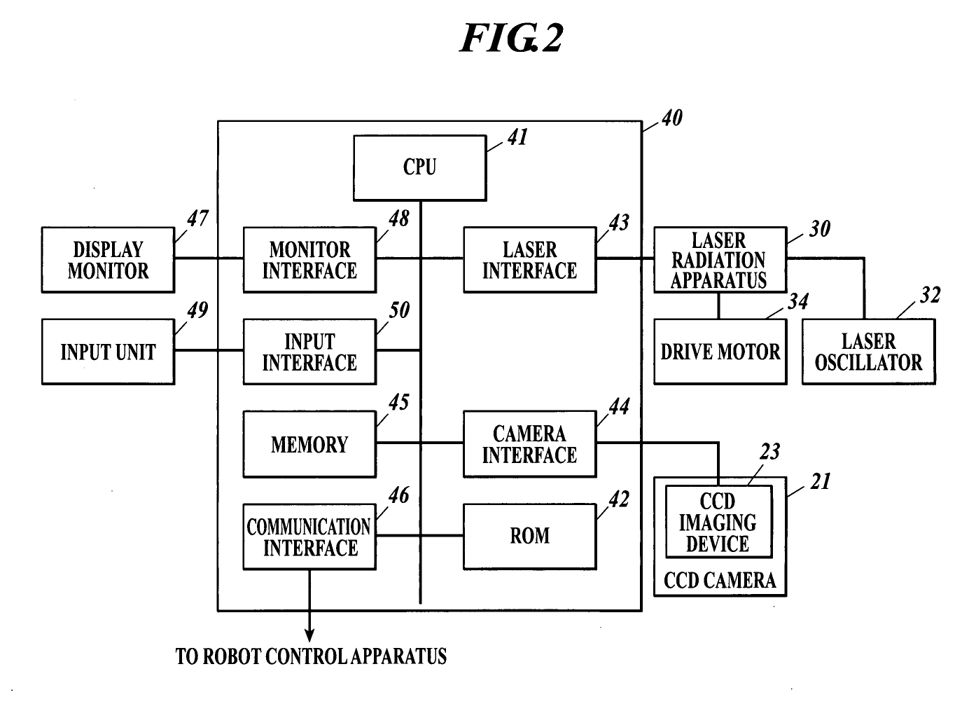

The scan mechanism 33 is equipped with servo motors 34 as drive motors (see FIG. 2) to perform the rotation drive of the laser oscillator 32 severally around the two axes perpendicular to each other. The rotation direction by one of the servo motors 34 is set so as to be a direction perpendicular to the slit light along which the radiation position of the slit light moves (the direction of an arrow F in FIG. 1). Consequently, the radiated slit light moves while parallelly keeping the shape of the slit light from the radiation position thereof, and can scan the whole irradiated surface with the slit light.

Moreover, although the other servo motor rotates the laser oscillator 32 so that the radiation position of the slit light may move in the direction in parallel to the slit light, the servo motor is used for the location of the scan position at the time of performing the scan by the laser light.

(Imaging Apparatus of Object Search Apparatus)

The imaging apparatus 20 is equipped with a CCD camera 21 for imaging, and a camera stand 22 to hold the CCD camera 21 so that the CCD camera 21 may image the top surface of the palette 11 above the stand 31 of the laser radiation apparatus 30.

The CCD camera 21 is equipped with a CCD imaging device 23 to detect an imaged image, and an optical system (not shown) to form the imaged image on a detection surface of the CCD imaging device 23.

The optical system mentioned above performs the image formation on almost the whole detection surface of the CCD imaging device 23 in order that the whole top surface of the pallet 11 may be the imaging area.

The CCD imaging device 23 is equipped with innumerable fine photo-detection pixels (photodiodes) provided on the detection surface (a surface on which the formation of an image is performed) of the CCD imaging device 23 in a state of being in lines both in length and breadth with equal intervals from each other, and each pixel outputs a voltage according to the luminance of a received light in the order of the alignment sequence. The image analysis apparatus 40 receives the output from the CCD imaging device 23, and generates image data according to an image in the imaging area (the region which is an imaging object, and in which imaging is performed to take in an image) from the order of the signal output from each pixel.

That is, a known number of pixels are severally provided to be in line in the longitudinal direction (supposed to be Y direction) and the lateral direction (supposed to be X direction), and these pixels performs outputting in a determined order. Consequently, the output of each pixel can be specified based on the order. Then, when only a part has different luminance from those of others in the imaging area of the CCD imaging device 23, it is possible to identify the position in the imaging area where luminance is peculiar by specifying the pixel outputting the different luminance value.

(Image Analysis Apparatus of Object Search Apparatus)

FIG. 2 is the block diagram showing the control system of the object search apparatus 10.

The image analysis apparatus 40 is equipped with a CPU 41 to perform various kinds of processing which will be described later, a ROM 42 storing processing programs executed by the CPU 41, a laser interface 43 to perform the operation control of the laser radiation apparatus 30, a camera interface 44 to receive an image signal from the CCD camera 21, a memory 45 to store various kinds of data in various kinds of processing executed by the CPU 41, a communication interface 46 to output an analysis result to the robot control apparatus 120, a monitor interface 48 to perform the connection with a display monitor 47 to perform predetermined displays in various kinds of processing by the CPU 41, and an input interface 50 to perform the connection with an input unit 49 to perform predetermined inputs in various kinds of processing by the CPU 41.

(Processing by Image Analysis Apparatus as Calibration Execution Unit)

By the configuration mentioned above, the image analysis apparatus 40 performs processing as a calibration execution unit. To put it concretely, the CPU 41 executes various kinds of processing in accordance with a pixel interval measurement program to specify which magnitude the interval between pixels of the CCD imaging device 23 of the imaging apparatus 20 takes in the imaging area, a camera distance calculation program to calculate the distance from the image formation lens of the optical system of the CCD camera 21 to the imaging area (the top surface of the pallet 11), and a laser angle calculation program to calculate a formula expressing each plane including a laser light emitted from the laser oscillator 32 at each scan position at the time of performing the scan of the imaging area at each interval with the laser light.

(Calibration Execution Unit: Pixel Interval Measurement Processing)

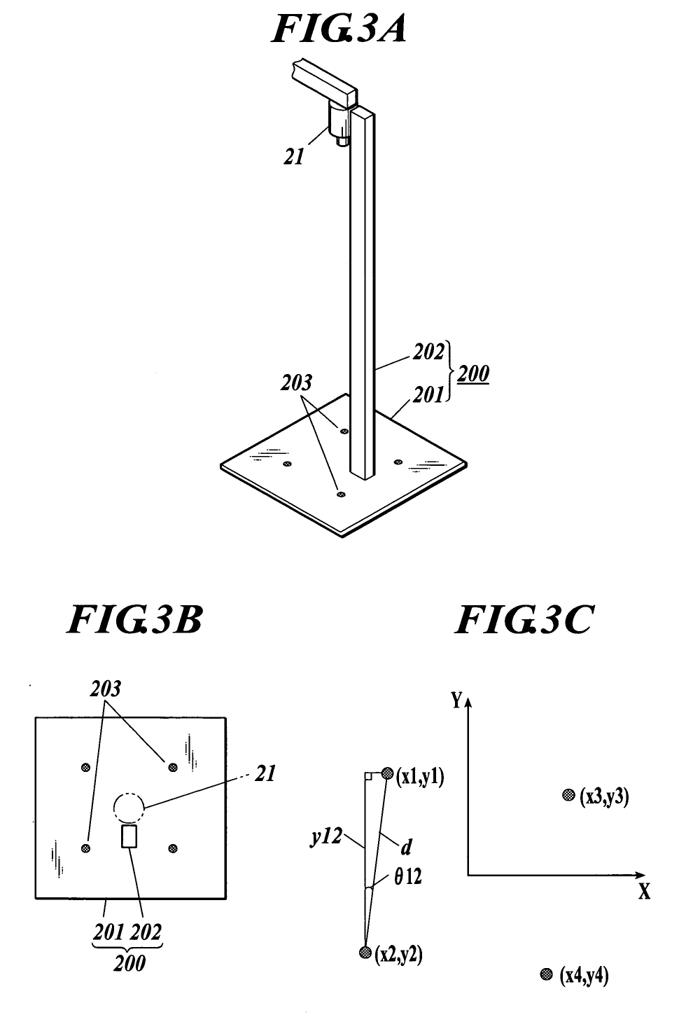

First, a jig 200 for interval measurement shown in FIGS. 3A, 3B and 3C is used at the time of the execution of the pixel interval measurement program.

As shown in FIG. 3A, the jig 200 is composed of a flat plate 201 placed on the plane to be the imaging area (the top surface of the pallet 11 in the present embodiment), and a rod-like body 202 for position adjustment of the CCD camera 21, which rod-like body 202 perpendicularly stands on the flat plate 201.

Four dot-like markings 203 are marked on the top surface of the flat plate 201 in an arrangement of a regular square. The actual measurement value of the distance K between adjacent markings 203 is previously registered in the memory 45.

Moreover, the flat plate 201 is equipped with a not shown height adjustment unit to perform the adjustment of the height vertically to the flat plate surface. The height can be adjusted to be almost the same height as the plane on which the jig 200 is placed (the top surface of the pallet 11) at the lowest position. The height adjustment unit is used in the state of being adjusted to the lowest height at the time of the processing based on the pixel interval measurement program.

The rod-like body 202 is provided to stand vertically to the flat plate 201. As shown in FIG. 3B, the upper end of the rod-like body 202 is abutted against the CCD camera 21 to make it possible to perform the position adjustment of the CCD camera 21 at the almost vertical upper part of the center position of the four markings 203.

Thereby, the CCD camera 21 supported to face to the vertical lower part can be made to image an image so that the center position of the four markings 203 may be located at almost the center of the imaging area.

FIG. 3C shows an imaged image by the CCD camera 21 when the jig 200 is located as mentioned above. The X axis and the Y axis of the diagram constitute a coordinate system of the CCD camera 21, and coincide with the alignment directions of each pixel of the CCD imaging device 23, mentioned above, in breadth and length, respectively.

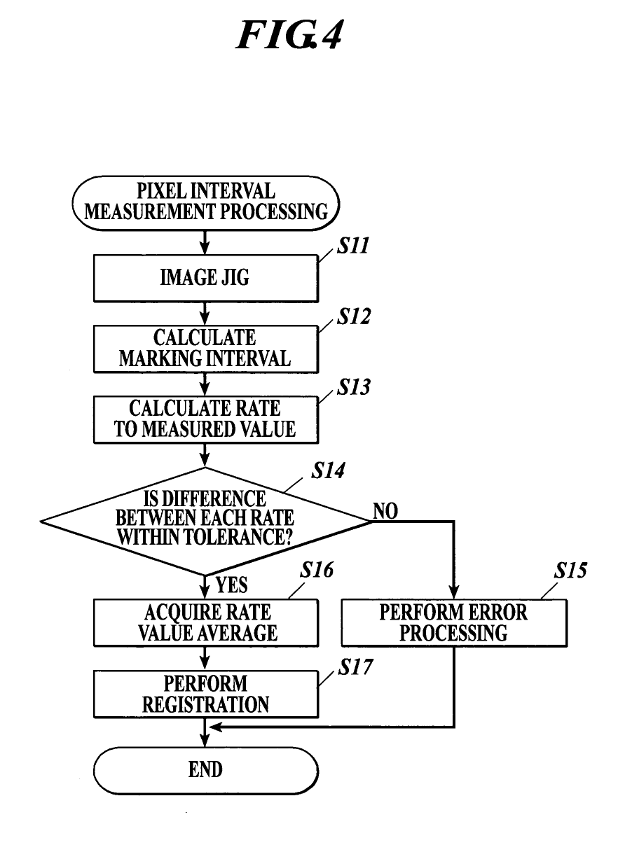

FIG. 4 shows a flowchart of the processing executed by the CPU 41 in accordance with the pixel interval measurement program.

By the execution of the pixel interval measurement program, the CPU 41 images each of the markings 203 of the jig 200 with the CCD camera 21 (Step S11).

Thereby, the CPU 41 acquires the position coordinates (x1, y1), (x2, y2), (x3, y3) and (x4, y4) of the camera coordinate system of the four markings 203 from the image data by the imaging. In addition, the extraction of each of the marking 203 in an imaged image is performed from a difference from the circumferential luminance at the time of the imaging.

In addition, the position coordinates of the camera coordinate system are expressed by the number of pixels arranged in a line in each direction of the CCD imaging device 23.

A distance y12 (=y1−y2) and an angle θ12 (=tan⁻¹((x1−x2)/(y1−y2))) are calculated from two adjoining position coordinates (x1, y1) and (x2, y2) among the four position coordinates (Step S12).

Because the distance between two markings 203 in the camera coordinate system can be acquired by y12/cos θ12, and the actual distance K has been registered in advance, if it is supposed that K=y12/cos θ12, an actual distance per pixel (rate of the real distance to a unit distance of the camera coordinate system) when the CCD camera 21 images the top surface of the pallet 11 is calculated by K·cos θ12/y12 (Step S13).

Moreover, the CPU 41 performs the same processing about the other couples of adjoining markings 203, and calculates actual distances per pixel to compare each value (Step S14). Thereby, when an abnormal difference from the viewpoint of a tolerance arises, the CPU 41 judges that the flat plate 201 of the jig 200 is not perpendicular to the visual line of the CCD camera 21 but some inclinations have arisen. Then, the CPU 41 performs an error display on a display monitor, and requests to perform the imaging again (Step S15).

Moreover, if the difference of each value is in the tolerance, the CPU 41 acquires the average value of each value (Step S16), and registers the acquired average value in the memory 45 as a value of the actual distance per pixel (Step S17).

(Calibration Execution Unit: Camera Distance Calculation Processing)

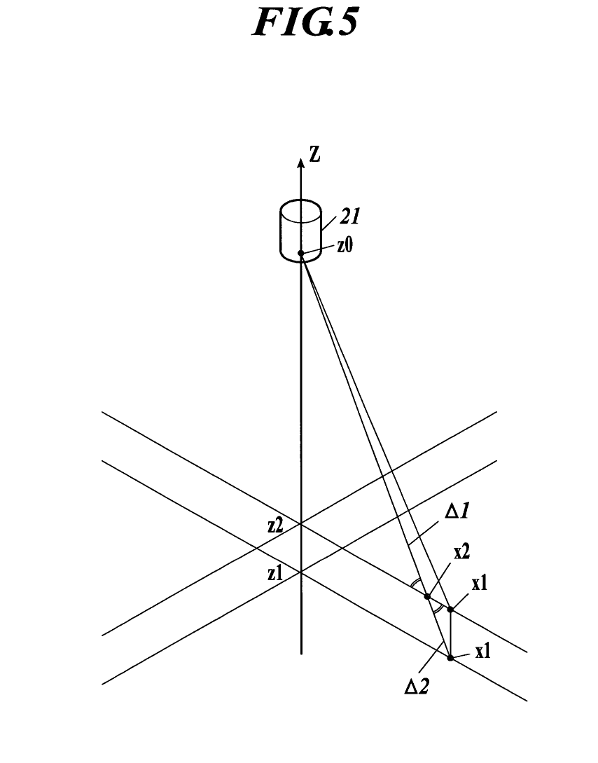

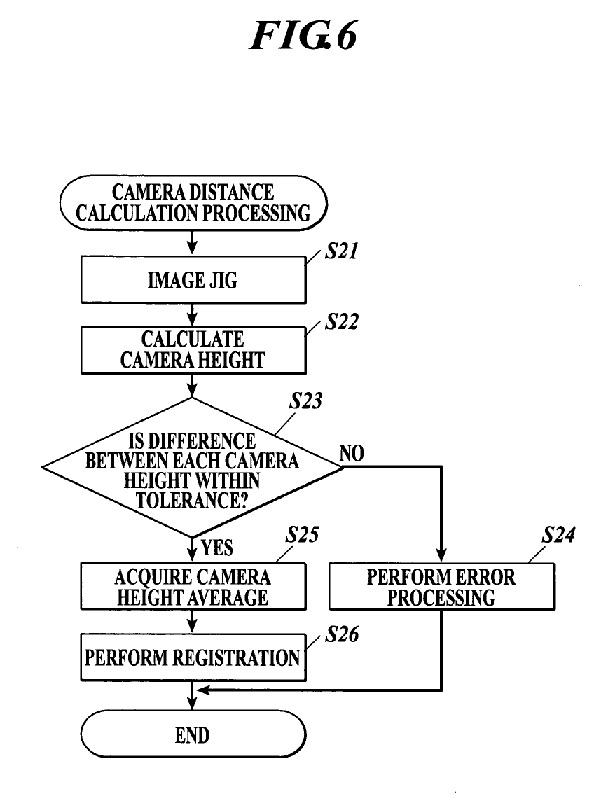

Next, the processing of the CPU 41 in accordance with the camera distance calculation program is described based on FIGS. 5 and 6. FIG. 5 is an explanatory view of the principle of the camera distance calculation processing, and FIG. 6 shows a flowchart executed by the CPU 41 in accordance with the camera distance calculation program. Hereupon, it is supposed that a direction perpendicular to the X direction and the Y direction is Z direction and the Z coordinate of the CCD camera 21 is z0 in the following description.

First, the jig 200 mentioned above is again used at the time of the execution of the camera distance calculation program. The height of the flat plate 201 of the jig 200 is adjusted in the Z direction, and the imaging of each of the markings 203 is performed in the state in which the flat plate 201 is adjusted to a lower position z1 equal to the height of the top surface of the pallet 11 and a higher position z2 severally. In this case, the X coordinate value of a marking 203 is x2 at the lower position z1 because the marking 203 is distant from the CCD camera 21, and the X coordinate value is x1 (>x2) at the higher position z2 as shown in FIG. 5.

Because triangles A1 and A2 are similar figures to each other in this case, the following formula (1) is true.
(x1−x2)/(z2−z1)=x2/(z0−z2) (1)

On the other hand, the height of the CCD camera 21 to be acquired can be acquired as z0−z1, and the upper formula (1) can be expanded to the following formula (2).
z0−z1=x1(z2−z1)/(x1−x2) (2)

Because the value of z2−z1 is the adjusted height (the difference between the lower position and the higher position) of the jig 200, the value can be beforehand registered in the memory 45, and because the values of x1 and x2 can be acquired by imaging, it is possible to calculate z0−z1, which indicates the height of the CCD camera 21.

The processing of the CPU 41 in accordance with the camera distance calculation program is described.

By the execution of the camera distance calculation program, the CPU 41 images the jig 200 at the lower poison and at the higher position with the CCD camera 21 (Step S21).

Thereby, the CPU 41 acquires the position coordinates (x1, y1), (x2, y2), (x3, y3) and (x4, y4) of the camera coordinate system of the four markings 203 from the image data by the imaging. In addition, the imaging at the lower position may use the image data acquired by the processing of the pixel interval measurement program. In that case, only the imaging at the higher position may be performed.

The CPU 41 calculates the value of z0−z1, which expresses the height of the CCD camera 21, from the amount of a change of the X coordinates in the imaged image between the X coordinates before and after the height adjustment and the amount of the height adjustment of the jig 200 (Step S22).

Moreover, the CPU 41 performs the same processing also to all the markings 203, and compares the value of the height of the CCD camera 21 which can be acquired from each processing (Step S23). Thereby, when an abnormal difference from the viewpoint of the tolerance has arisen, the CPU 41 judges that the height adjustment of the flat plate 201 of the jig 200 has performed not perpendicularly to the visual line of the CCD camera 21 but has performed with some arisen inclinations. Then, the CPU 41 performs an error display on the display monitor, and requests to perform the imaging again (Step S24).

Moreover, if the difference of each value is in the tolerance, the CPU 41 acquires the average value of each value (Step S25), and registers the acquired average value in the memory 45 as the height of the CCD camera 21 (Step S26).

(Calibration Execution Unit: Laser Angle Calculation Processing)

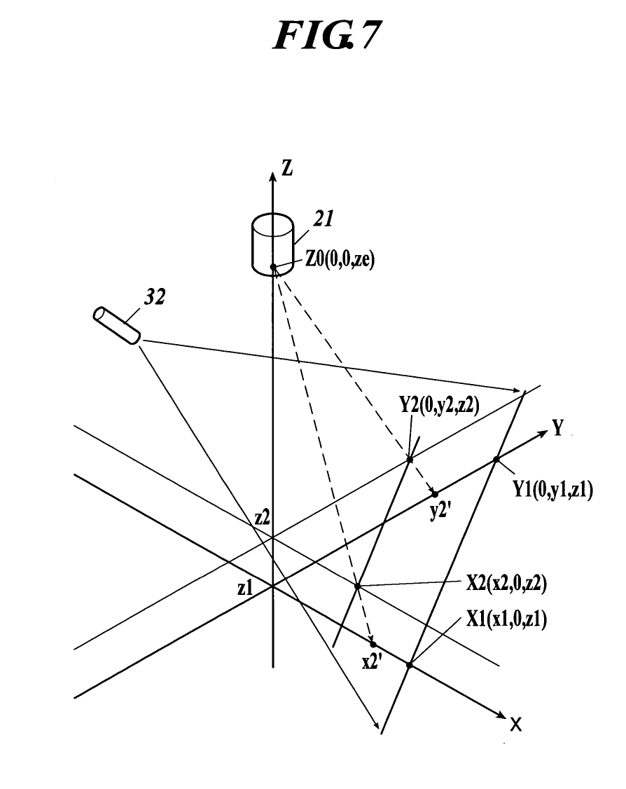

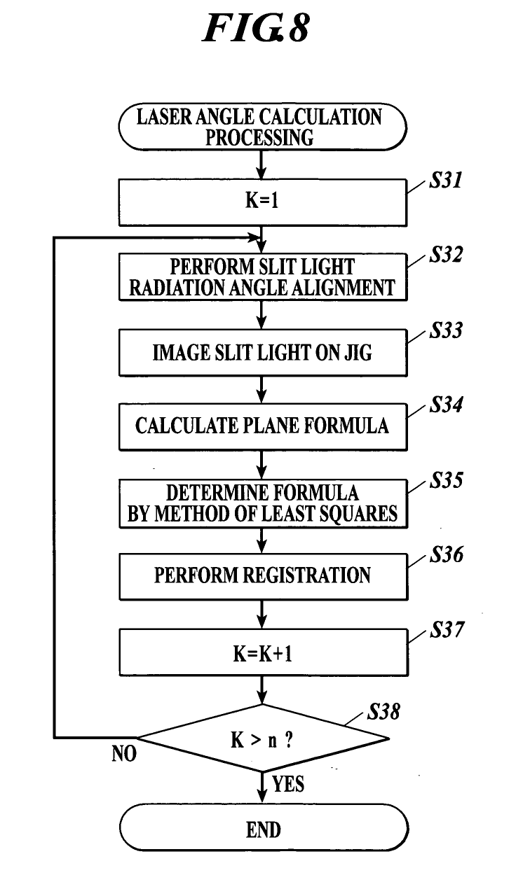

Next, the processing of the CPU 41 in accordance with the laser angle calculation program is described based on FIGS. 7 and 8. FIG. 7 is an explanatory view of the principle of the laser angle calculation processing, and FIG. 8 shows a flowchart of the processing executed by the CPU 41 in accordance with the laser angle calculation program.

The laser radiation apparatus 30 performs the radiation of a slit light, shifting the radiation position of the slit light into the direction perpendicular to the slit light with a fixed interval, in order to acquire height data of each point group according to the number of the pixels of the CCD imaging device 23 and the scan density of the slit light in the range of the top surface of the pallet 11, which is the imaging area. The imaging with the CCD camera 21 is performed at each shifted radiation position.

Then, in order to calculate height data of each pixel to which the slit light has been imaged, there is the necessity of acquiring the formula of the plane containing the slit light, and for this reason the laser angle calculation processing is performed.

In addition, the feed of the fixed interval of the slit light at the time of the scan of the imaging area is determined by the rotation angle of the servo motor 34 of the scan mechanism 33 of the laser radiation apparatus 30, and all of the individual rotation angles at the time of the scan are registered in the memory 45 in advance. Moreover, as the rotation angle range of the servo motor 34, the range from a start angle to an end angle is registered according to the imaging area. Thereby, the CPU 41 calculates the scan number of slit lights.

Then, in the laser angle calculation processing, the calculation of the formula of the planes containing all the slit lights at the individual rotation angles is performed.

The jig 200 mentioned above is also used at the time of the execution of the laser angle calculation program. First, the height of the flat plate 201 of the jig 200 is adjusted in the Z direction to the slit light radiated in the state of being fixed at an angle so that the slit light irradiates a predetermined scan position, and imaging is performed in the state in which the flat plate 201 is adjusted to the lower position z1 equal to the height of the top surface of the pallet 11 and the higher position z2 severally.

If it is supposed that the X intercepts of the slit light severally imaged at the lower position and the higher position are denoted by x1 and x2 and the Y intercepts thereof are dented by y1 and y2, each point in FIG. 7 is expressed as follows: X1=(x1, 0, z1), Y1=(0, y1, z1), X2=(x2, 0, z2), Y2=(0, y2, z2).

A vector directed from the point X1 to the point Y1 is expressed by (−x1, y1, 0), and the magnitude thereof is (x1²+y1²)^{1/2}.

Moreover, a vector directed from the point X1 to the point Y2 is expressed by (−x1, y2, z2−z1), and the magnitude thereof is (x1²+y2²+(z2−z)²)^{1/2}.

Moreover, the direction cosine of one vector becomes (x1²+y1²)^{-1/2}·(−x1, y1, 0). Hereupon, the direction cosine is replaced with (11, m1, n1).

Moreover, the direction cosine of the other vector becomes (x1²+y2²+(z2−z1)²)^{-1/2}·(−x1, y2, z2−z1) Hereupon the direction cosine is replaced with (12, m2, n2).

A plane containing these direction cosines and passing the point X1 can be acquired by the following formula (3).
m1·n2·(x−x1)−12·n1·y−11·m2·(z−z1)=0 (3)

Now, as the values of z1 and z2, the heights of the jig 200 at the time of imaging may be registered in advance, and the values of x1 and y1 can be acquired by the detection of the CCD camera 21. But, because the values of x2 and y2 are the positions when the jig 200 is set at the higher position, the values of x2 and y2 cannot be directly acquired.

That is, as shown in FIG. 7, the CCD camera 21 detects the values of x2′ and y2′ instead of the values of x2 and y2.

However, because x2′=x2·(z0−z1)/(z0−z2) and y2′=y2·(z0−z1)/(z0−z2) are true, the values x2 and y2 can be calculated from the detected values x2′ and y2′.

Consequently, the CPU 41 can calculate the formula of the plane containing the laser slit light by the imaging of the slit light.

Then, the formulae of the planes are calculated as for the laser slit light at all the radiation angles, and the calculated formulae are registered in the memory 45.

The processing of the CPU 41 in accordance with the laser angle calculation program is described.

First, the CPU 41 sets a count value K of the scan number of the slit light to 1 by the execution of the laser angle calculation program (Step S31).

Then, the CPU 41 reads the rotation angle of the servo motor 34 of the laser radiation apparatus 30 from the memory 45, and the CPU 41 drives the servo motor 34 to make the rotation angle coincide with the radiation angle of the present scan number (Step S32).

The CPU 41 images the slit light projected on the jig 200 at the lower position and the higher position with the CCD camera 21 (Step S33).

Thereby, the CPU 41 calculates the position coordinates of the four points X1, X2, Y1 and Y2, and further calculates the formula of the plane containing the slit light from the registered values of the heights of the jig 200 (Step S34).

Then, at this time, the CPU 41 creates combinations of three points among the four points X1, X2, Y1 and Y2, and calculates the plane formula from each of the combinations (Step S35).

The CPU 41 acquires the formula of one plane by averaging each coefficient of the formula or by the method of least squares, and registers the acquired formula in the memory 45 (Step S36).

Next, the CPU 41 adds one to the count value of the scan number (Step S37), and judges whether the scan number has reached the scheduled whole scan number or not (Step S38). When the scan number has not reached the whole scan number, the CPU 41 returns the processing to Step S32, and performs the plane calculation at the next radiation angle. When the scan number has reached the entire scan number, the CPU 41 ends the processing.

(Processing as Master Data Acquisition Unit by Image Analysis Apparatus)

Furthermore, by the execution of the CPU 41 of a master data acquisition program in the ROM 42, the image analysis apparatus 40, which includes the CPU 41, executes the processing as a master data acquisition unit by calculating the master data of a workpiece W in a certain direction and by calculating the master data in a plurality of directions. The image analysis apparatus 40 calculates the master data of the workpiece W in the certain direction by imaging the workpiece W with the imaging apparatus 20 while performing the scan of the laser slit light with the laser radiation apparatus 30. The image analysis apparatus 40 calculates the master data in the plurality of directions by coordinate conversions changing the direction of the master data.

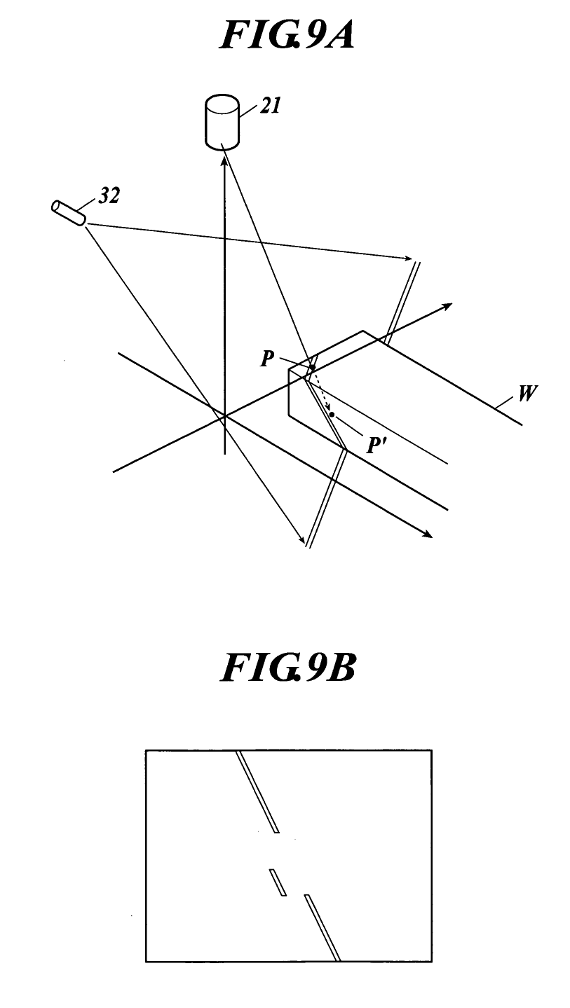

Here, the techniques of imaging with the laser slit light and of generating three-dimensional data by the imaging are described with reference to FIGS. 9A and 9B. FIG. 9A is an explanatory view of a state in which a laser slit light is radiated at a certain radiation angle to a workpiece W placed in an imaging area. FIG. 9B shows an imaged image by the imaging.

When the laser slit light is radiated from an oblique direction to a part projecting from a plane, a state in which the laser slit light deforms from the straight line part and a shift is generated at a part having a height according to the shape of the part is imaged.

A certain point P on the workpiece W shown in FIG. 9A is detected as a point P′ (x′, y′, z1) where the camera visual line intersects the top surface of the pallet 11 when the camera visual line is taken down from the point P because the CCD imaging device 23 is a plane sensor, even if the actual three-dimensional coordinate of the point P is (x, y, z). In addition, in practice, only x′ and y′ are the position coordinates acquired by the imaged image of the CCD imaging device 23, and z1 is the Z coordinate value of the top surface of the pallet 11 mentioned above.

Then, because a height ze of the CCD camera 21 has been acquired by the calibration, the three-dimensional coordinate (x, y, z) of the point P of the workpiece W can be acquired by calculating the intersecting point of a straight line connecting the camera position (0, 0, ze) and the detected point P′ (x′, y′, z1) and the plane containing the laser slit light (the afore-mentioned formula (3) acquired by the calibration) from the respective formulae.

A three-dimensional coordinate is calculated to each point over the full length of the slit light image imaged by one time of imaging by the way mentioned above. Furthermore, the whole imaging area is scanned with the laser slit light, and the three-dimensional coordinates are calculated to every radiation angle.

Then, all the data other than those of the workpiece W, namely the data of the position coordinates (z=z1) indicating the top surface of the pallet 11, among the obtained three-dimensional data to every radiation angle are roved, and then the coordinate values acquired by each scan are synthesized. Thereby, the three-dimensional data of the workpiece W in the state of facing in the direction placed on the pallet 11 can be acquired. The three-dimensional data becomes the data as a point group according to the scan density of the laser slit light on the surface of the workpiece W and the pixel density of the CCD imaging device 23.

On the convenience of the processing at the time of searching the workpiece W by comparing the three-dimensional data based on the imaged image in the imaging area, which will be described later, one point of the point group of the three-dimensional data of the workpiece W is determined as a reference point (which may be an arbitrary point), and the three-dimensional data is converted to the data as vectors directing from the reference point to all the points other than the reference point. That is, the reference point is set to (0, 0, 0), and the other points can be acquired by (the position coordinate of the calculated three-dimensional data—the position coordinate of the original reference point), and the acquired vectors are registered as the master data.

Moreover, because the object search apparatus 10 aims to discover one workpiece out of a plurality of workpieces W confusedly piled up on the palette 11, it is not certain in which direction around the X, the Y and the Z axes the workpiece W to be searched for inclines, and consequently the master data in the state in which the workpiece W faces each direction is needed.

Accordingly, the angle conversions of the coordinate values of the maser data facing the certain direction acquired by the technique mentioned above are performed around each axis of the X, the Y and the Z axes to perform the registration of the master data of the workpiece W facing each direction also. For example, when the angle conversion is performed to every 5° within a range of from 0° to 180° around each axis of the X, the Y and the Z axes, master data pertaining to the combinations of these angles are also prepared. Consequently, 36×36×36=46656 pieces of master data are calculated and registered.

In addition, in the case of a workpiece W forming quite different forms according to the directions in which the workpiece W is placed, it is desirable to acquire the plurality of pieces of master data in each direction to register the plurality of pieces of master data. For example, if the forms of the front and the back of the workpiece W are completely different from each other, it is desirable to image each of the front surface and the back surface to generate each piece of master data, and further to rotate each piece of master data to generate the rotated master data to register in the memory 45.

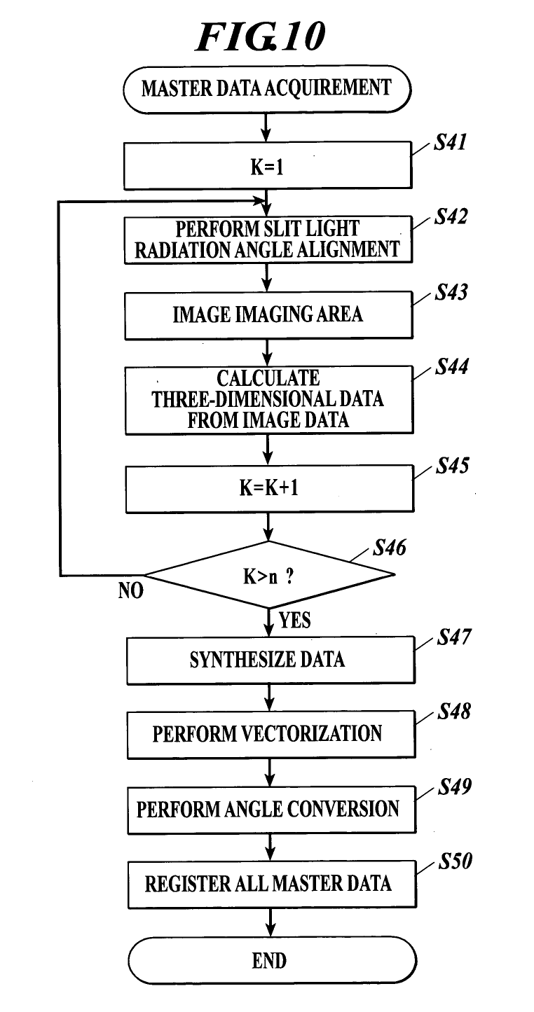

The processing of the CPU 41 in accordance with the master data acquisition program is described. FIG. 10 shows the flowchart of the processing executed by the CPU 41 in accordance with the master data acquisition program.

First, the CPU 41 sets the count value K of the scan number of the slit light to 1 by the execution of the master data acquisition program (Step S41).

Then, the CPU 41 reads the rotation angle of the servo motor 34 of the laser radiation apparatus 30 from the memory 45, and the CPU 41 drives the servo motor 34 to make the rotation angle coincide with the radiation angle of the present scan number (Step S42).

The CPU 41 performs imaging of the slit light in the imaging area with the CCD camera 21 (Step S43).

At this time, the CPU 41 performs binarization processing to extract only the data of the pixels having luminance of a threshold value, which has been previously set to image data by imaging, or more to extract only the data of a slit light image from the imaged image. The CPU 41 calculates three-dimensional data from the image data of the slit light (Step S44).

Next, the CPU 41 adds one to the count value of the scan number (Step S45), and judges whether the scan number has reached the scheduled whole scan number or not (Step S46). When the scan number has not reached the scheduled whole scan number, the CPU 41 returns the processing to Step S42, and performs the calculation of three-dimensional data at the next radiation angle.

When the whole scan has been completed on the other hand, the CPU 41 removes the data of the top surface of the pallet 11 from the acquired three-dimensional data, and performs synthesis (Step S47).

Furthermore, the CPU 41 arbitrarily determines a reference point from the synthesized three-dimensional data, and generates master data by attaining the vectorization to make each point be a position vector from the reference point (Step S48).

Then, the CPU 41 performs the angle conversion of the master data of one direction around each axis (Step S49).

Then, the CPU 41 registers all the master data of the workpiece W facing each direction in the memory 45 (Step S50).

In addition, the memory 45 at this case is equivalent to a master data storage unit to store each master data of the workpiece W facing the plurality of directions.

In stead of Step S49, Steps S41-48 may be repeated while the direction of the workpiece W is changed in various directions, so as to obtain the master data of the workpiece W in all directions.

(Processing as Three-Dimensional Analysis Unit by Image Analysis Apparatus)

Furthermore, by the execution of the CPU 41 of a three-dimensional analysis program in the ROM 42, the image analysis apparatus 40, which includes the CPU 41, executes the processing as a three-dimensional analysis unit to perform imaging while performing the scan of a laser slit light in a state in which a plurality of workpieces W are confusedly piled up on the pallet 11, and to calculate imaging area three-dimensional data indicating the position coordinate of a point group created by breaking down the imaging area from the image data acquired by the imaging according to the pixel density of the CCD imaging device and the scan density of the laser slit light.

Because the imaging of the laser slit light and the principle of the generation of the imaging area three-dimensional data based on the imaging are the same as those of the generation of the master data, their descriptions are omitted, and only different respects are described.

That is, in the generation of the imaging area three-dimensional data, the CPU 41 first synthesizes three-dimensional data acquired by the imaging of each laser slit light. After the CPU 41 has removed the data corresponding to the top surface of the palette 11, the CPU 41 records the synthesized three-dimensional data as the imaging area three-dimensional data in the memory 45 without performing the vectorization thereof.

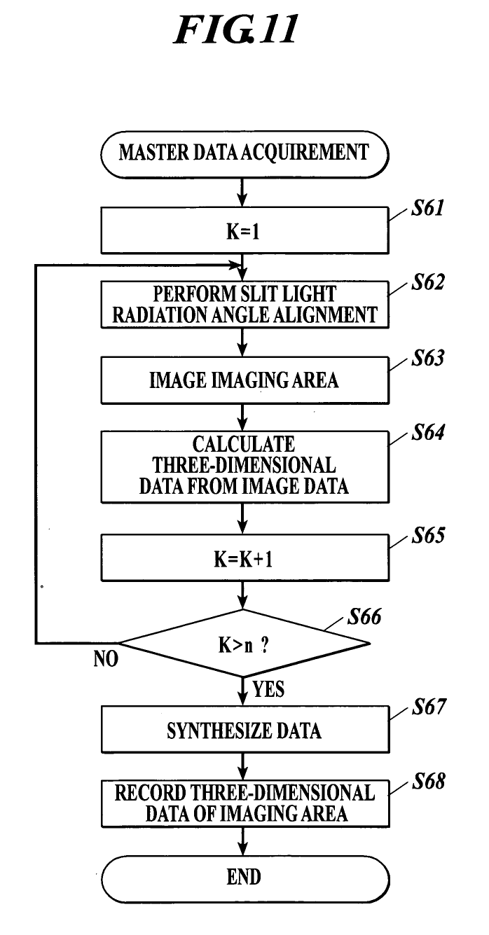

The processing of the CPU 41 in accordance with the three-dimensional analysis program is described. FIG. 11 shows a flowchart of the processing executed by the CPU 41 in accordance with the three-dimensional analysis program.

First, the CPU 41 sets the count value K of the scan number of the slit light to 1 by the execution of the three-dimensional analysis program (Step S61).

Then, the CPU 41 reads the rotation angle of the servo motor 34 of the laser radiation apparatus 30 from the memory 45, and the CPU 41 drives the servo motor 34 to make the rotation angle coincide with the radiation angle of the present scan number (Step S62).

The CPU 41 performs imaging of the slit light in the imaging area with the CCD camera 21 (Step S63).

Next, the CPU 41 calculates three-dimensional data from the binarized image data of the slit light (Step S64).

Next, the CPU 41 adds one to the count value of the scan number (Step S65), and judges whether the scan number has reached the scheduled whole scan number or not (Step S66). When the scan number has not reached the scheduled whole scan number, the CPU 41 returns the processing to Step S62, and performs the calculation of the three-dimensional data at the next radiation angle.

When the scheduled whole scan has been completed on the other hand, the CPU 41 removes the data of the top surface of the pallet 11 from the acquired three-dimensional data, and performs synthesis (Step S67).

Then, the CPU 41 records the synthesized imaging area three-dimensional data in the memory 45 (Step 68). (Processing as Judgment Unit by Image Analysis Apparatus) Furthermore, by the execution of the CPU 41 of a judgment program in the ROM 42, the image analysis apparatus 40, which includes the CPU 41, judges whether the position coordinate of each point of the master data in any direction approximates to the position coordinate of each point of three-dimensional data or not when the position adjustment of the reference point of the master data in each direction is performed to each point of the imaging area three-dimensional data of the imaging area acquired by the three-dimensional analysis.

Moreover, in such a judgment program, the CPU 41 further performs a second judgment to the points adjoining with more dense intervals from one another only in the circumference of the points having high degrees of approximation as a result of performing a first judgment to some points arranged with a predetermined interval between them among the point group of the imaging area three-dimensional data.

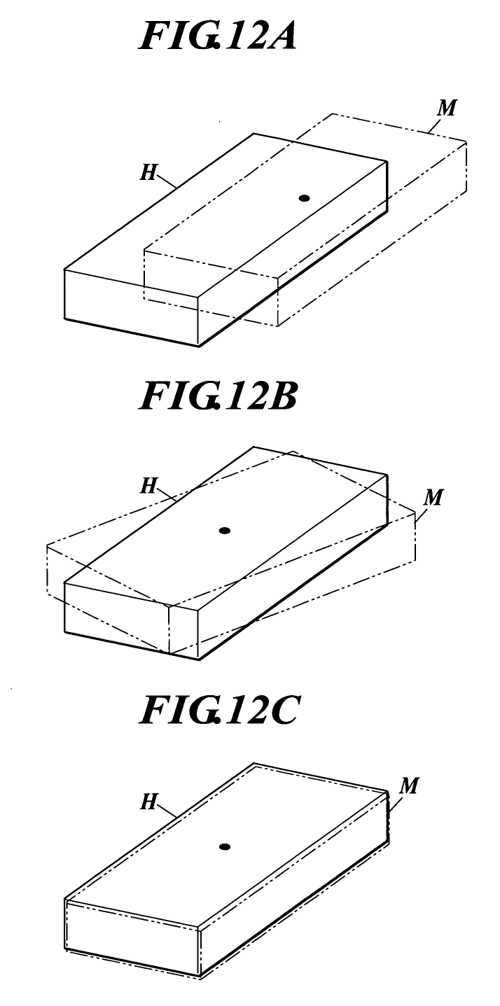

The judgment processing performed in accordance with the judgment program mentioned above is described in detail. FIGS. 12A, 12B and 12C are explanatory views of the principle in the judgment processing.

That is, the image analysis apparatus 40 performs the master data acquisition processing and the three-dimensional data analysis processing to store the master data in each direction and the imaging area three-dimensional data in the memory 45. Any of these pieces of data can be considered to be a set of the point groups existing in juxtaposition in plane according to the pixel density and the scan density of a CCD imaging device.

Here, if it is supposed that an arbitrary point in any piece of the master data is set as the reference point and the reference point is located at any point in the imaging area three-dimensional data, the position of each point in each point group M of the master data and in each point group H constituting the workpiece surface in the imaging area three-dimensional data hardly coincides with each other nor approximate to each other, as shown in FIG. 12A, if the reference point is not located at a point corresponding to the reference point of the workpiece in the imaging area three-dimensional data.

Moreover, also if the master data having a different direction is selected and the reference point is located at any point in the imaging area three-dimensional data, the position of each point in each point group M of the master data and in the point group H constituting the workpiece surface in the imaging three-dimensional data hardly coincides with each other nor approximates to each other, as shown in FIG. 12B.

However, if the master data of the right direction is selected and the reference point of the master data is located at a point corresponding to the reference point of the point group constituting the workpiece in the point group of the three-dimensional data in the imaging area to be applied, the position of each point in each point group M of the master data and in the point group H constituting the workpiece surface in the imaging area three-dimensional data coincides with each other or approximates to each other, as shown in FIG. 12C.

If the position coordinate of the reference point of master data is converted so as to be the position coordinate of a point in the point group constituting the imaging area three-dimensional data and the position coordinates of the other point groups of the master data are converted by the same position changing quantity in the same direction, the whole master data can be located in the imaging area. That is, if the position coordinate values of one point selected from the imaging area three-dimensional data are added to the whole coordinate value including the reference point of the master data, the application of the master data can be performed.

Then,

(1) each point which has been subjected to the position conversion is compared with each point of the imaging area three-dimensional data, and an evaluation point based on a proximity distance is given to each point of the master data to sum up the whole;

(2) it is judged whether an approximate point within a predetermined distance exists in the imaging area three-dimensional data or not to each point of the master data which has been subjected to the position conversion, and the number of the existing points is set as the evaluation point; and

a coincidence judgment is performed when the evaluation point exceeds a rated value.

The approach judgment of the point group of the master data to the point group of the three-dimensional data of the imaging area may be performed with the other known methods.

Moreover, if the application, the judgment and the like of the master data are performed to all the points of the imaging area three-dimensional data, the processing load of the CPU 41 becomes too large, and the processing speed thereof lowers in the judgment processing mentioned above. Consequently, the judgment is divided into a primary judgment, which is roughly and totally performed, and a secondary judgment, which is finely performed, to be stepwise performed.

That is, if all the point groups of the imaging area three-dimensional data exist from PM1 to PMk, the point groups are thinned out in a certain arrangement interval from the whole point group, and thinned-out imaging area three-dimensional data including decreased point groups PS1-PSn is prepared (m>n hereupon).

Then, the application of the reference point of each master data is performed to each point of the thinned-out imaging area three-dimensional data, and an approximation evaluation is performed.

In this case, a first coincidence condition, which is an evaluation criterion to the thinned-out imaging area three-dimensional data, is loosely set in comparison with a second coincidence condition, which is an evaluation criterion to the dense imaging area three-dimensional data. For example, an evaluation point at which the coincidence judgment is performed is set to be lower, a judgment distance to judge a point to be an approximate point is set to be larger, or the like.

When the primary judgment is passed thereby, the points judged so that the points approximate to the former points exist in the other point groups between those of the master data and those of the imaging area three-dimensional data are gathered, and the minimum coordinate value and the maximum coordinate value are calculated in each of the X direction and the Y direction among the gathered points.

Only some point groups (hereinafter referred to as PMj-PMk) which are in the range of from the minimum value to the maximum value in the X axis direction and in the range of from the minimum value to the maximum value in the Y axis direction are extracted from the point groups PM1-PMm of the dense imaging area three-dimensional data, and the secondary judgment is executed.

Thereby, the regions in which the possibility of the existence of the workpieces W is low are taken off from the objects of the fine judgment, and it is possible to perform the fine judgment only to the regions in which the probability of the existence of the workpieces W is high.

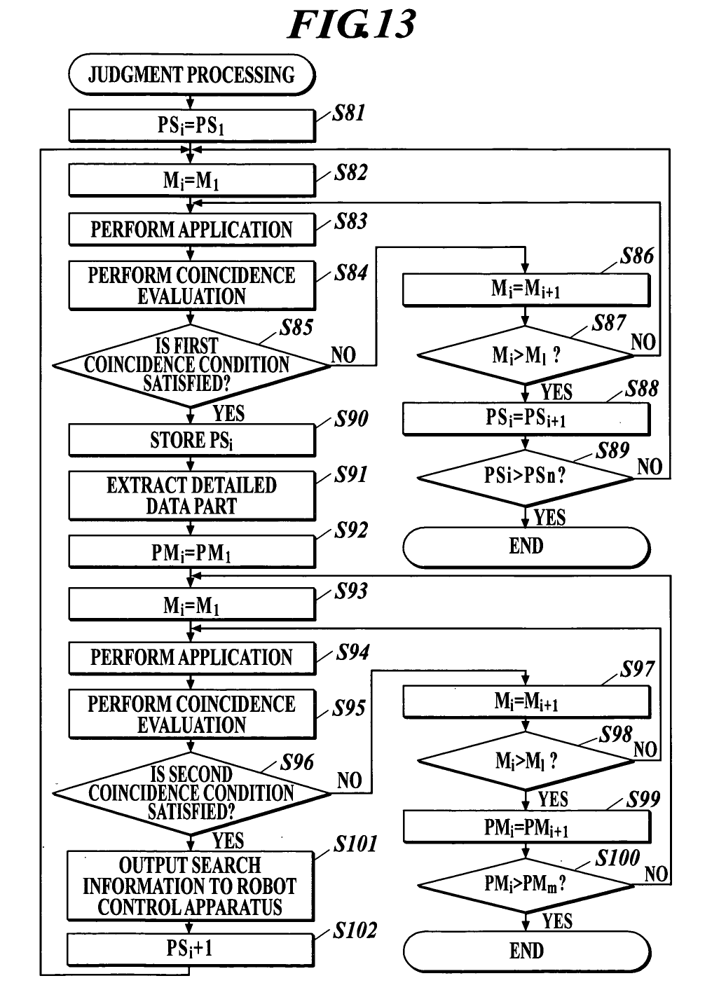

The processing of the CPU 41 in accordance with the judgment program is described. FIG. 13 shows a flowchart of the processing executed by the CPU 41 in accordance with the judgment program.

First, the primary judgment is performed. That is, the CPU 41 reads the thinned-out imaging area three-dimensional data from the memory 45, and selects a first point PS1 among the read data (Step S81).

Next, the CPU 41 selects the master data M1, to which application is performed (Step S82).

Then, the position of the point group of the master data M1 is converted so that the reference point of the master data M1 may be positioned at the position of the selected point PS1 (Step S83).

The approximation judgment of each point of the master data M1 which has been subjected to the position conversion and each point of the thinned-out imaging area three-dimensional data is performed, and a coincidence evaluation is performed based on the first coincidence condition, which condition is looser (Step S84).

When the coincidence evaluation cannot be acquired by this (Step S85), the next master data is selected (Step S86), and the judgment of whether all pieces of the master data has been selected or not is performed (Step S87).

When not all pieces of the master data have been selected, the processing is returned to Step S83, and the application and the coincidence evaluation are performed to the next master data.

Moreover, when the application of all pieces of the master data has been performed, the next point of the thinned-out imaging area three-dimensional data is selected (Step S88), and the judgment of whether all the points have been selected or not is performed (Step S89).

When all the points of the thinned-out imaging area three-dimensional data have been selected as a result, the processing is ended.

Moreover, when not all the points of the thinned-out imaging area three-dimensional data have been selected, the processing is returned to Step S82, and the application of each piece of the master data is performed to the next point.

On the other hand, if the coincidence evaluation can be acquired at the judgment at Step S85, the order of the point PSi at which the coincidence evaluation has been acquired is stored (Step S90), and the processing advances to the secondary judgment.

That is, the CPU 41 reads dense imaging area three-dimensional data from the memory 45, and extracts the points PMj-PMk in a partial range with the technique mentioned above out of the read data (Step S91).

A first point PMj is then selected from the points PMj-PMk (Step S92).

Next, the master data M1 to which application is performed is selected (Step S93).

Then, the position conversion of the point group of the master data M1 is performed so that the reference point of the master data M1 may be the position of the selected point PMj (Step S94).

The approximation judgment between each point of the master data M1, which has been subjected to the position conversion, and each point of the dense imaging area three-dimensional data is performed, and the coincidence evaluation is performed based on the second coincidence condition, which is more strict (Step S95).

When no coincidence evaluation can be acquired by this (Step S96), the next master data is selected (Step S97), and judgment of whether all pieces of the master data have been selected or not is performed (Step S98).

Thereby, when the application has not been performed to all pieces of the master data, the processing is returned to Step S94, and the application and the coincidence evaluation are performed to the next master data.

Moreover, when the application of all pieces of the master data has been completed, the next point of the dense imaging area three-dimensional data is selected (Step S99), and the judgment of whether all of the points have been selected or not is performed (Step S100).

When all of the dense imaging area three-dimensional data have been selected as a result, the processing is ended.

Moreover, when not all the points of the dense imaging area three-dimensional data are selected, the processing is returned to Step S93, and the application of each master data is performed to the next point.

On the other hand, when the coincidence evaluation is acquired by the judgment at Step S96, the three-dimensional data of the master data, which has been subjected to the position conversion so as to perform the application of the reference point to the point PMi at which the coincidence evaluation has been acquired, is output to the robot control apparatus 120 through the communication interface 46 and a communication harness (Step S101).

On the other hand, the coincidence evaluation by the secondary judgment about the point at which it is accepted that an approximate point exists to the master data is deleted from the point group of the dense imaging area three-dimensional data. The reason of the deletion is that the coincidence evaluation becomes unnecessary at the time of the next continued judgment.

Similarly, the point corresponding to the point at which it is accepted that an approximate point exists to the master data by the secondary judgment is deleted also from the point group of the thinned-out imaging area three-dimensional data.

That is, an update is severally performed to the new thinned-out imaging area three-dimensional data a part of which has been deleted and the dense imaging area three-dimensional data in the memory 45.

Next, the point PSi at which the primary judgment has been intercepted and which is stored by the processing at Step S90 is read, and the processing is returned to Step S82. The primary judgment to the next point is restarted about the thinned-out imaging area three-dimensional data (Step S102).

(Robot)

Next, the robot 110 of the robot system 100 is described based on FIG. 1.

The robot 110 is equipped with a base 111 to be a foundation, a plurality of arms 112 coupled at joints 113, a servomotor (not shown) provided to each of the joints 113 as a drive source, an encoder (not shown) to detect the axial angle of each servomotor, and the hand 114 provided at the leading edge of the coupled arm 112 as a tool to nip and hold a workpiece W.

Each of the joints 113 consists of either of a rocking joint to enable rocking of one end of an arm 112 and support the axis of another arm at the end thereof, and a rotation joint to rotatably support the axis of an arm 112 itself at the center in the lengthwise direction of the arm 112. That is, the robot 110 of the present embodiment corresponds to the so-called articulated robot.

Moreover, the robot 110 is provided with six joints 113 (a part of them is not shown) to enable the hand 114 at the end be located at an arbitrary position to take an arbitrary posture.

Moreover, the hand 114 is equipped with a servo motor as a drive source, and two nipping claws capable of becoming apart and close to each other with the servomotor. Because the pair of nipping claws of the hand 114 always moves to just the intermediate position between them by one servo motor, the location of the hand 114 is set to be performed with a reference of the intermediate position.

(Robot Control Apparatus)

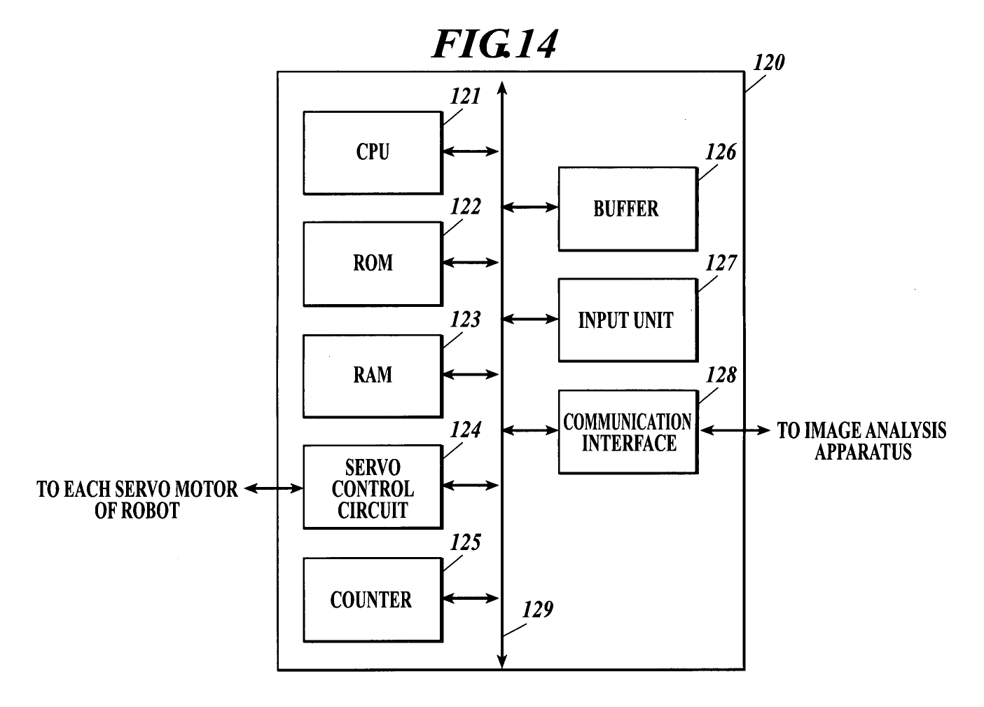

FIG. 14 is a block diagram of the robot control apparatus 120.

The robot control apparatus 120 is equipped with a ROM 122 storing a system program to control the whole robot control apparatus 120, a control program to perform the operation control of the robot 110, and various initial setting data; a CPU 121 to execute various programs stored in the ROM 122; a RAM 123 to function as a work area in which various data are stored by the processing of the CPU 121; a servo control circuit 124 to perform the electrification of a servomotor drive current according to the torque value of the servomotor of each of the joints 113 of the robot 110, which drive current is determined in accordance with a control program executed by the CPU 121; a counter 125 to count an encoder output of each of the joints 113; a memory 126 as a storage unit to store various pieces of data pertaining to the control of the robot 110, which data is requested by the processing of the control program; an input unit 127 composed of, for example, a keyboard and the interface thereof for inputting the nipping point of the robot 110 and the other various settings; a communication interface 128 to receive an analysis result from the image analysis apparatus 40; and a bus 129 to connect each of the components mentioned above.

In addition, although the counter 125 and the servo control circuit 124 are individually provided to the servomotor of each of the joints 113 of the robot 110, they are omitting to be shown in FIG. 14.

The robot control apparatus 120 performs the operation control of the robot 110 in accordance with a robot coordinate system different from the coordinate system of the CCD camera 21, which the image analysis apparatus 40 handles.

Consequently, when the robot control apparatus 120 receives three-dimensional data indicating the position and the direction of a workpiece W based on the coordinate system of the image analysis apparatus 40 from the communication interface 128, the robot control apparatus 120 cannot take in the three-dimensional data therein as it is.

Accordingly, a calibration with regard to the robot control apparatus 120 and the image analysis apparatus 40 may be performed in accordance with a well-known technique. Alternatively, a conversion program may be prepared in the ROM 122 in order to calculate a conversion formula (conversion matrix) to convert the coordinate system data of the image analysis apparatus 40 into the data of the robot coordinate system by the operations of the CPU 121 by performing nipping at a reference position (e.g. the original point, a point on the X axis, the Y axis or the Z axis, or the like) of the coordinate system of the image analysis apparatus 40 while operating the robot 110 using the input unit 127.

Moreover, similarly the arrangement of the pallet 11, the arrangement of the CCD camera 21, the arrangements of the optical axis and the laser oscillator 32, and the like may be input as data.

When the CPU 121 has converted the three-dimensional data indicating the position and the direction of the workpiece W, which has been received from the image analysis apparatus 40, into the data of the robot coordinate system in such a way, the CPU 121 acquires a feature point or the like for performing the nipping of the workpiece W with the hand 114 by performing an operation to determine the arm end position of the robot 110, and executes the operation control to locate the arm end at the position.

Furthermore, the CPU 121 executes operation control to make the had 114 nip the workpiece W by performing the operation control thereof, to make the arm end of the robot 110 move to a predetermined carry position, and to make the hand 114 release the workpiece W toward a predetermined direction.

(Effects of Robot System)

As mentioned above, the object search apparatus 10 of the robot system 100 searches the position of a workpiece W based on whether the position coordinate of each of the other points approximates to the reference point of the master data or not as a result of performing the position adjustment of the reference point to one point of the imaging area three-dimensional data. Consequently, even if a plurality of workpieces W are in the state of being confusedly piled up and imaging area three-dimensional data acquired by imaging shows a complex mode, it is possible to search one workpiece W by the approximation of a part of the workpieces W.

Furthermore, because the master data from every possible direction is prepared to judger the respective resemblances, a search is possible even if the workpieces W face a different directions one anther, and it is also possible to specify the directions of the workpieces W.

Moreover, because the robot control apparatus 120 utilizes the search result of the object search apparatus 10, the robot control apparatus 120 can hold and carry one workpiece W among a plurality of workpieces W piled up confusedly, even if they are in such a state, with the hand 114, and consequently there is no use to previously arrange the workpieces W in a fixed rule, or to previously input the method of the arrangement in order to perform an operation of the robot 110 to make it possible to attain the reduction of the operation loads such as them.

Moreover, because the object search apparatus 10 acquires master data by using the imaging apparatus 20 and the laser radiation apparatus 30 freely, a search can be performed without acquiring the maser data of a workpiece W by a numeral calculation, inputting data, or previously preparing data.

Similarly, the robot control apparatus 120 does not also need to create or input the initial data of a workpiece W which should be treated, and the robot control apparatus 120 can perform an operation even if a workpiece is unknown.

Moreover, when the image analysis apparatus 40 acquires the master data of a workpiece W, it becomes possible to prepare the master data having a high degree of coincidence at the time of an approximation judgment by making the scan conditions and the imaging conditions equal to each other, and it becomes possible to improve search accuracy.

Because the object search apparatus 10 stepwise performs a primary judgment and a secondary judgment at the time of performing the position adjustment of one point of master data and the judgment of approximation, the object search apparatus 10 cannot be required to perform the position adjustment and the secondary judgment of master data to all of the point groups of the dense imaging area three-dimensional data.

As a result, it is possible to attain the reduction of processing loads and the speeding up of the processing by reducing the accuracy of a judgment as much as possible.

(Others)

Although the laser light radiation apparatus mentioned above radiated a slit light, the light to be radiated is not limited to the slit light. For example, a laser light radiation apparatus which emits a spot light may be used. In that case, the scan of the whole imaging area is performed by performing a scan of a spot light in a sub scan direction (e.g. the same direction as the line of the slit light) while performing the scan in the main scan direction (the direction perpendicular to the sub scan direction).

Moreover, although the laser radiation apparatus 30 performs the scan of the laser slit light by directly rotating the laser oscillator, the method of the scan of the laser slit light is not limited to such one. The other generally known optical scan techniques may be used for it. For example, a method of fixing the laser oscillator and rotating or revolving the reflection surface of a mirror reflecting the emitted laser light may be used.

In addition, in the processing of the judgment unit, only a part of the master data changing by a larger uniform angle may be used also with regard to the master data at the time of the coincidence judgment of sparse imaging area three-dimensional data. For example, although the master data of posture changing by every 5° is used in the present embodiment, for example, the processing using only a part of the master data by a more sparse every 15° interval may be used in the coincidence judgment of the sparse imaging area three-dimensional data.

The entire disclosure of Japanese Patent Application No. 2005-287421 filed on Sep. 30, 2006, including description, claims, drawings and summary are incorporated herein by reference.

What is claimed is:

1. An object search apparatus, comprising:
an imaging unit to acquire image data of a point group acquired by imaging and breaking down an imaging area;
a radiation unit to scan the imaging area with laser light;
a three-dimensional analysis unit to calculate three-dimensional data indicating position coordinates of the point group acquired by breaking down the imaging area, from the image data acquired by scanning of the radiation unit with the laser light;
a master data storage unit to store a master data which is each of the three-dimensional data of a search object to be searched in the imaging area in a plurality of directions; and
a judgment unit to position one point of the master data in each direction to each point of the three-dimensional data, to judge whether position coordinates of points of the positioned master data in any direction approach to position coordinates of corresponding points of the three-dimensional data of the imaging area, and to perform a search of the search object based on a result of the judgment.

2. The object search apparatus according to claim 1, further comprising:
a master data acquisition unit to acquire the master data of the search object in a plurality of directions by the imaging unit imaging the search object while the radiation unit scanning the search object with the laser light.

3. The object search apparatus according to claim 1, further comprising:
a master data acquisition unit to calculate the master data of the search object in a certain direction by the imaging unit imaging the search object while the radiation unit scanning the search object with the laser light, and to calculate the master data in a plurality of directions by coordinate conversion to change a direction of the master data.

4. The object search apparatus according to claim 1, wherein the judgment unit performs the judgment on a part of points arranged at predetermined interval among the point group of the three-dimensional data of the imaging area acquired by the three-dimensional analysis unit, and further performs the judgment on points arranged at denser interval than the predetermined interval only within a circumference of the point at which a degree of approximation has judged high.

5. A robot system equipped with the object search apparatus according to claim 1, comprising:
a robot to hold a tool to perform an operation to the search object; and
a robot control apparatus to control the robot to move and position the tool based on a position of the search object acquired by the search apparatus.

6. The robot system according to claim 5, wherein the tool is a hand to hold the search object, and the robot control apparatus controls the robot to hold and carry the search object with the hand based on a position and a direction of the search object acquired by the search apparatus.

7. An object search method using an object search apparatus comprising an imaging unit to acquire image data of a point group acquired by imaging and breaking down an imaging area, a radiation unit to scan the imaging area with laser light, a three-dimensional analysis unit to calculate three-dimensional data indicating position coordinates of the point group acquired by breaking down the imaging area from the image data acquired by scanning with the laser light, and a master data storage unit to store a master data which is each of the three-dimensional data of a search object to be searched in the imaging area in a plurality of directions, the method comprising the steps of:
positioning one point of the master data in each direction to each point of the three-dimensional data of the imaging area acquired by the three-dimensional analysis unit;
judging whether position coordinates of points of the positioned master data in any direction approach to position coordinates of corresponding points of the three-dimensional data; and
specifying a direction and a position of the search object based on a result of the judgment.

8. The object search method according to claim 7, further comprising the steps of:
acquiring the master data of the search object in a plurality of directions by the imaging unit imaging the search object while the radiation unit scanning of the search object with the laser light.

9. The object search method according to claim 7, further comprising the steps of:
calculating the master data of the search object in a certain direction by the imaging unit imaging the search object while the radiation unit scanning the search object with the laser light; and
calculating the master data in a plurality of directions by coordinate conversion to change a direction of the master data.

10. The object search method according to claim 7, wherein the positioning and the judging are performed to a part of points arranged at predetermined interval among the point group of the three-dimensional data of the imaging area acquired by the three-dimensional analysis unit, and further are performed to points arranged at denser interval than the predetermined interval only within a circumference of the point at which a degree of approximation has judged high.
